(19) United States
(12) Patent Application Publication
(10) Pub. No.: US 2022/0414803 A1
(43) Pub. Date: Dec. 29, 2022

(54) STORAGE TANK MANAGEMENT SYSTEM AND STORAGE TANK MANAGEMENT METHOD

(71) Applicant: J-OIL MILLS, Inc., Tokyo (JP)

(72) Inventors: Takeshi SUZUKI, Tokyo (JP); Masami INOUE, Tokyo (JP); Kazuhiko HAKAMADA, Tokyo (JP); Shinsuke KOZONO, Tokyo (JP); Kenichi WATANABE, Tokyo (JP)

(21) Appl. No.: 17/760,827

(22) PCT Filed: Oct. 29, 2020
(86) PCT No.: PCT/JP2020/040601

§ 371 Date: Mar. 16, 2022

(30) Foreign Application Priority Data
Nov. 13, 2019 (JP) 2019-205584

(51) Int. Cl. G06Q 50/12; A47J 37/12; G06Q 10/08; G06Q 30/06

(52) U.S. Cl. CPC G06Q 50/12; A47J 37/1271; G06Q 10/087; G06Q 30/0633

(57) ABSTRACT

A frying oil ordering device 60 comprises a remaining amount recognition unit 61 that recognizes an amount of frying oil 17 remaining in a storage tank 33, and an ordering timing determination unit 62 that determines an ordering timing for the storage tank 33 to be replenished with the frying oil 17 based on the remaining amount and at least one of information regarding replacing the frying oil 17 in a fryer 14 in a facility 32, and parameters that affect future sales of fried foods 19 in the facility 32.

### TECHNICAL FIELD

The present invention relates to a system and method for managing a storage tank that is installed as incidental equipment in a facility in which fried foods are sold and frying oil used for the fried foods is stored.

### BACKGROUND ART

In shops where fried foods are fried and sold on the premises, the fried foods are displayed in a display section of the shop, and customers purchase the desired types of fried foods from the fried foods displayed in the display section. Therefore, the fried foods must be fried in a fryer in the shop and arranged in advance so that the fried foods are displayed in the proper amounts in the display section in the shop.

Frying oil in an oil tank of the fryer deteriorates due to the cooking of the fried foods. Therefore, in order to maintain the quality of fried foods as cooked products, the frying oil in the oil tank needs to be replaced as appropriate so that the degree of deterioration does not exceed a predetermined upper limit.

Therefore, in a facility where fried foods are sold, a storage tank in which frying oil is stored is installed as incidental equipment, and when the frying oil in the oil tank has deteriorated, the deteriorated frying oil in the oil tank is discarded, the oil tank is cleaned, and the oil tank is then replenished with new frying oil from the oil tank.

Individual facilities order frying oil for the storage tank from a predetermined contractor, and the facilities receive delivery and replenishment of the frying oil. Therefore, ordering timing needs to be properly managed in facilities so that there is no interference with the cooking of fried foods in the fryer.

Techniques such as those described in Patent Documents 1 and 2 are examples of techniques for managing the amount of fuel remaining in a storage tank. In devices for managing the amount of LP gas remaining in a tank in Patent Documents 1 and 2, a future amount remaining in the tank is predicted based on the amount of LP gas remaining in the tank at a given moment and the predicted LP gas consumption from that moment on. According to the prediction, a gas supply contractor then visits the tank installation site to replenish the LP gas.

### PRIOR ART DOCUMENTS

### Patent Documents

[Patent Document 1] Japanese Laid-Open Patent Application No. 2019-20830
[Patent Document 2] Japanese Laid-Open Patent Application No. 2019-20831

### DISCLOSURE OF THE INVENTION

### [Problems the Invention is Intended to Solve]

Replenishing a storage tank with frying oil used to cook fried foods in a facility is replenishing a storage tank in which the amount of frying oil remaining has been detected.

In the replenishing of LP gas in Patent Documents 1 and 2, the tank is replaced altogether. Specifically, at each site where a tank is installed, LP gas is replenished by replacing an empty tank with a tank filled with the maximum amount of LP gas.

However, the timing at which frying oil for the storage tank is ordered must be determined by taking into account not only the remaining amount but also properties unique to the frying oil. The frying oil in the storage tank deteriorates even if the remaining amount does not change. In addition, the future amount of frying oil remaining will be greatly affected by the replacement of frying oil in the fryer in the facility and the future sales of fried foods in the facility.

Therefore, the methods of replenishing LP gas in Patent Documents 1 and 2 could not be applied unmodified to replenishing frying oil in a frying oil storage tank installed in a shop or the like.

An object of the present invention is to provide a storage tank management system and a storage tank management method that can properly manage a storage tank which is installed as incidental equipment in a shop where fried foods are sold, and in which frying oil used for the fried foods is stored.

### [Means for Solving the Aforementioned Problems]

A storage tank management system of the present invention is

a system for managing a storage tank which is installed as incidental equipment in a facility where fried foods to be sold are cooked, and in which frying oil used for the fried foods is stored, the storage tank management system comprising:

a remaining amount recognition unit configured to that recognizes an amount of frying oil remaining in the storage tank; and

an ordering timing determination unit configured to determine an ordering timing for the storage tank to be replenished with the frying oil based on the remaining amount recognized by the remaining amount recognition unit and at least one of a degree of deterioration of the frying oil in the storage tank, information regarding replacing the frying oil in a fryer in the facility, and parameter information relating to parameters that affect future sales of the fried foods.

According to the storage tank management system of the present invention, the ordering timing for the frying oil is determined by considering, in addition to the amount of the frying oil remaining in the storage tank, at least one of a degree of deterioration of the frying oil in the storage tank, information regarding replacing the frying oil in a fryer in the facility, and parameter information relating to parameters that affect future sales of the fried foods in the facility.

Specifically, in this management system, the ordering timing for the frying oil is determined by considering factors important for determining the ordering timing for the frying oil, such as the degree of deterioration and the shop status. As a consequence, the amount of the frying oil remaining in the storage tank can be properly managed, and the storage tank, which does not hinder the cooking of the fried foods in the shop, can be properly managed.

Preferably, the storage tank management system of the present invention further comprises an ordering unit configured to place an order with an order recipient for the frying oil based on the ordering timing determined by the ordering timing determination unit.

According to this configuration, an ordering unit is provided separately from the ordering timing determination unit. The ordering unit can thereby place an order in consideration of factors (e.g., a delivery date convenient for the schedule of the facility) other than the ordering timing determined by the ordering timing determination unit. The ordering by the ordering unit may be performed automatically. In such instances, it is possible to place an order at an appropriate timing without the need for a manager, etc., to place an order individually.

Preferably, the storage tank management system of the present invention further comprises

a deterioration prediction unit configured to predict the degree of deterioration of the frying oil in the storage tank, and

the ordering timing determination unit determines the ordering timing such that the degree of deterioration predicted by the deterioration prediction unit can be maintained within an allowable range.

The frying oil in the storage tank undergoes oil and fat oxidation and other deterioration with the passage of time due to, inter alia, contact with air in the storage tank. Because the frying oil that has undergone such deterioration has already deteriorated even after replacement, the frying oil affects characteristics of the fried food such as taste and color, and will need to be replaced again in a short period of time.

Therefore, according to this configuration, the degree of deterioration of the frying oil in the storage tank is predicted, and the ordering timing is determined such that the degree of deterioration can be maintained within the allowable range. Suitable taste, color, and other characteristics can thereby be maintained in the cooked food cooked with the replaced frying oil.

Preferably, in the storage tank management system of the present invention,

the deterioration prediction unit predicts the degree of deterioration using an amount of head space in the storage tank as one assessment factor, and

the ordering timing determination unit determines the ordering timing so as not to exceed the amount of head space needed in order to maintain the degree of deterioration within the allowable range.

The frying oil in the storage tank deteriorates due to contact with air in the head space. As the amount of head space increases, the amount of air in the storage tank increases commensurately; therefore, as the amount of head space increases, the deterioration rate of the frying oil in the storage tank increases commensurately and the fried foods lose flavor commensurately sooner.

With this configuration, by determining the ordering timing so as not to exceed the amount of head space needed in order to maintain the degree of deterioration within the allowable range, it is possible to manage the frying oil in the storage tank so as not to cause the fried foods cooked with the frying oil in the storage tank to lose flavor.

Preferably, in the storage tank management system of the present invention,

the deterioration prediction unit predicts the degree of deterioration using an elapsed time from a time of replenishment when the storage tank is replenished with the frying oil in the storage tank as one assessment factor, and

the ordering timing determination unit determines the ordering timing such that the elapsed time from the time of replenishment when the storage tank is replenished with the frying oil in the storage tank is maintained within the time needed to maintain the degree of deterioration within the allowable range.

The frying oil in the storage tank deteriorates as contact time with the air in the head space increases. According to this configuration, it is possible to increase the accuracy of determining the ordering timing for maintaining the degree of deterioration within the allowable range, by having the determination of the ordering timing involve the time elapsed from the time of replenishment when the storage tank was replenished with the frying oil in the storage tank.

Preferably, in the storage tank management system of the present invention,

the deterioration prediction unit predicts the degree of deterioration at the time of replenishment as a replenishment-time degree of deterioration based on a ratio of a replenishment amount at the time the storage tank was replenished with the frying oil in the storage tank to the amount of the frying oil remaining immediately before the replenishment, and predicts the degree of deterioration of the frying oil in the storage tank after an elapsed time from the time of replenishment based on the replenishment-time degree of deterioration and the elapsed time from the time of replenishment.

When the storage tank is replenished with frying oil, the old frying oil before the replenishment and the replenished new frying oil mix together. Therefore, the degree of deterioration of the frying oil in the storage tank immediately after the replenishment is related to a ratio of the amount of the frying oil remaining immediately before the replenishment to the replenishment amount of the frying oil. Furthermore, the frying oil in the storage tank deteriorates with the passage of time after the replenishment.

According to this configuration, by predicting the degree of deterioration of the frying oil in the storage tank after an elapsed time from the time of replenishment based on the replenishment-time degree of deterioration and the elapsed time from the time of replenishment, it is possible to properly predict the degree of deterioration of the frying oil after replenishment. The ordering timing can thereby be made proper.

Preferably, the storage tank management system of the present invention further comprises a replacement information recognition unit configured to recognize the information regarding replacing the frying oil in the fryer in the facility, and

the ordering timing determination unit determines the ordering timing by considering the replacement information recognized by the replacement information recognition unit.

Because the frying oil in the storage tank is used to cook fried foods in a fryer in a shop, the future amount of the frying oil remaining in the storage tank is affected by the frequency with which the frying oil in the fryer is replaced.

According to this configuration, because the ordering timing is determined by considering information regarding replacing the frying oil in the fryer, it is possible to determine an ordering timing coordinated with the consumption of frying oil in the fryer.

Preferably, the storage tank management system of the present invention

further comprises a parameter information recognition unit configured to recognize as parameter information at least one parameter among attributes of a shop which is the facility, information relating to events that affect sales of the fried foods in the shop, future predicted sales predicted based on past sales performance of the fried foods by type, time to cook the fried foods by type, the present date and time, the degree of deterioration of the frying oil, and weather information, and

the ordering timing determination unit determines the ordering timing by considering the parameter information recognized by the parameter information recognition unit.

Because the frying oil in the storage tank is consumed in accordance with the sales of the fried foods in the facility, the future amount of the frying oil remaining in the storage tank is affected by the parameter information, which is related to the sales of the fried foods in the facility.

According to this configuration, because the ordering timing is determined by considering parameter information, it is possible to determine an ordering timing coordinated with the future sales of the fried foods in the facility.

Preferably, the storage tank management system of the present invention further comprises

an ordering unit configured to place an order with an order recipient for the frying oil based on the ordering timing determined by the ordering timing determination unit, and an order recipient server that is managed by a manufacture of the frying oil and that serves as the order recipient for the frying oil, and

the order recipient server comprises

an order reception unit configured to receive the order from the ordering unit, and

a production plan formulation unit configured to formulate a plan for producing the frying oil based on the order received by the order reception unit

According to this configuration, the order recipient server formulates a plan for producing the frying oil based on the order for the frying oil from the facility, and the manufacturer can thereby produce the frying oil to meet demand for the frying oil in the facility.

A storage tank management method of the present invention is a method for managing a storage tank which is installed as incidental equipment in a facility where fried foods to be sold are cooked, and in which frying oil used for the fried foods is stored, the storage tank management method comprising the steps of:

recognizing an amount of frying oil remaining in the storage tank; and

determining an ordering timing for the storage tank to be replenished with the frying oil based on the remaining amount recognized in the remaining amount recognition step and at least one of a degree of deterioration of the frying oil in the storage tank, information regarding replacing the frying oil in a fryer in the facility, and parameter information relating to parameters that affect future sales of the fried foods.

According to the storage tank management method of the present invention, the ordering timing for the frying oil is determined by considering, in addition to the amount of the frying oil remaining in the storage tank, at least one of a degree of deterioration of the frying oil in the storage tank, information regarding replacing the frying oil in a fryer in the facility, and parameter information relating to parameters that affect future sales of the fried foods in the facility.

Specifically, in this management method, the ordering timing for the frying oil is determined by considering factors important for determining the ordering timing for the frying oil, such as the degree of deterioration and the shop status. As a consequence, the amount of the frying oil remaining in the storage tank can be properly managed, and the storage tank, which does not hinder the cooking of the fried foods in the shop, can be properly managed.

### BRIEF DESCRIPTION OF THE DRAWINGS

FIG. 1 shows a kitchen where fried foods to be sold to customers are cooked;

FIG. 2 shows a display case in a shop;

FIG. 3 is a front view of a storage tank in which frying oil is stored;

FIG. 4 is a schematic view of a network system that sends and receives data and information via the internet;

FIG. 5 is a function block diagram of a frying oil ordering device;

FIG. 6 is a function block diagram of a storage tank management system;

FIG. 7 is a flowchart of a frying oil ordering method within a storage tank management method;

FIG. 8 is a flowchart of a production planning method within the storage tank management method;

FIG. 9 is a graph schematically depicting a relationship between an amount of head space Hs in the storage tank and a deterioration rate Ds of frying oil in the storage tank;

FIG. 10 is a graph schematically depicting changes over time in a remaining amount Or (solid lines) and a degree of deterioration De (dashed lines) of the frying oil in the storage tank when the remaining amount is small and the frying oil is replaced; and

FIG. 11 is a graph schematically depicting changes over time in the remaining amount Or (solid lines) and the degree of deterioration De (dashed lines) of the frying oil in the storage tank when the remaining amount is large and the frying oil is replaced.

### BEST MODE FOR CARRYING OUT THE INVENTION

A preferred embodiment of the present invention is described in detail below. In the following description, like reference symbols are used for substantially the same or equivalent elements and components. In addition, for elements that have the same element name and the same composition, reference symbols are used that have the same numbers but different letters of the alphabet. When multiple elements having the same element name and the same composition are collectively referred to, the alphabet letters are omitted and a reference symbol of only the number is used.

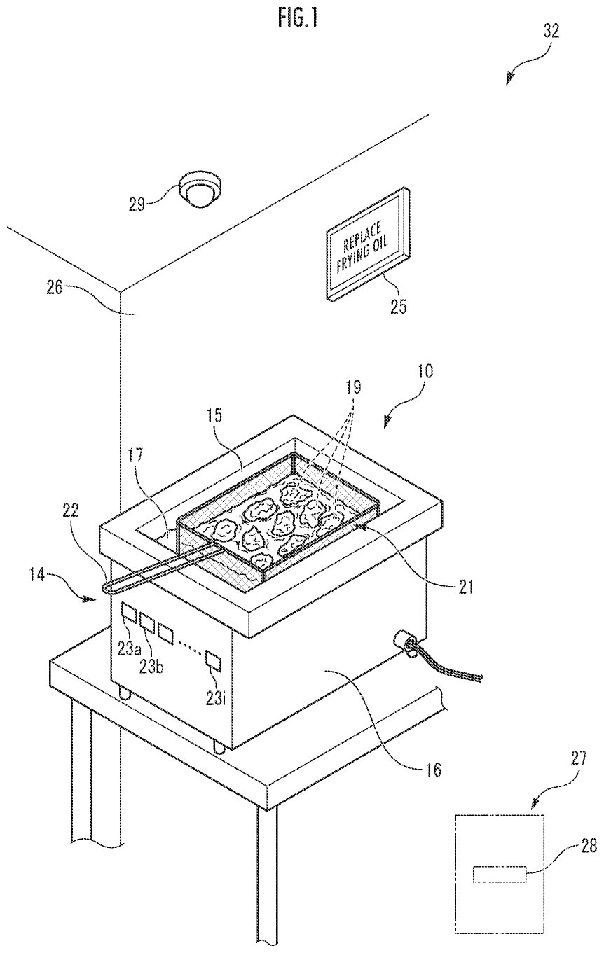

(Kitchen) FIG. 1 shows a kitchen 10 where fried foods 19 to be sold to customers are cooked. A shop such as a convenience shop or a supermarket is used below as an example of a facility 32. The facility 32 is not specified to be a shop, and the term “facility” could include a convenience store vendor, and a factory such as the central kitchen of a chain store.

The kitchen 10 is provided in the facility 32, and an electric fryer 14 is installed in the kitchen. The fryer 14 has an oil tank 15 and a housing 16 that accommodates the oil tank 15.

An upper side of the oil tank 15 is opened, and the oil tank 15 is provided in an upper part of the housing 16. Frying oil 17 is filled in the oil tank 15 until reaching a predetermined height. The fried foods 19 are placed in a frying basket 21 that has a handle 22, and are then immersed in the frying oil 17, which is heated, in the oil tank 15.

The types of fried foods 19 (e.g., (fried) chicken, potatoes, and croquettes) that are placed together in the frying basket 21 and immersed together in the frying oil 17 are usually often the same. Specifically, the immersion time (frying time) in the frying oil 17 is different for each type of fried foods 19, and since the different kinds of fried foods 19 have different immersion times, it is difficult to fry different foods at the same time.

A plurality of button switches 23a, 23b, . . . , 23i are provided in an outer surface of the housing 16 according to the types of fried foods 19, and when a button switch corresponding to a fried food 19 is pressed, and an immersion time suited to the fried food 19 has elapsed, either a buzzer sound is outputted from a speaker (not shown) of the fryer 14 or a display 25 in a wall 26 displays that frying has ended.

A switch for adjusting the temperature of the frying oil 17 may be provided for each type of fried food 19. However, because the temperature of the frying oil 17 often does not change appreciably depending on the type of the fried food 19, it is sufficient if the temperature can be set to a specific temperature.

A camera 29 is hung from the ceiling or attached to the wall 26. The camera 29, which may be either a video camera or a still camera, captures the state in the oil tank 15 of the fryer 14 continuously or at regular time intervals. The type, number, etc., of fried foods 19 in the frying basket 21 can be detected from an output image of the camera 29.

An information processing device 27 (e.g., a personal computer) is set up inside or outside the facility 32, and shop business software 28 is installed on the device 27. The information processing device 27 sends data to, and receives data from, the display 25 and the camera 29.

The type, number, etc., of fried foods 19 in the frying basket 21 can be detected from captured image data sent from the camera 29 to the information processing device 27.

Furthermore, the time over which each type of fried food 19 is fried can also be detected because whether or not the frying basket 21 has been loaded into the oil tank 15 can be detected from the image captured by the camera 29.

When frying is performed using the frying oil 17, first, a cook, who is a shopworker assigned to cooking, puts the fried food 19 into the frying basket 21, and then hangs the frying basket 21 on an upper end of a peripheral wall of the oil tank 15, or submerges the frying basket 21 until the bottom of the frying basket 21 touches the bottom of the oil tank 15, so that all of the fried foods 19 in the frying basket 21 are immersed in the frying oil 17. The cook then presses one button switch 23 corresponding to the type of fried food 19 to be fried in the given instance.

As previously described, when the immersion time set specific to the type of fried food 19 in the fryer 14 elapses, a buzzer sound or another sound is emitted or the display 25 displays the time elapse.

As a result, the cook becomes aware that the current session of frying has ended and pulls up the frying basket 21 to take out the fried food 19 from the oil tank 15. The frying basket 21 can be raised and lowered automatically by providing a drive mechanism.

It is also possible to connect the fryer 14 and the information processing device 27 in a wired or wireless scheme such that data can be sent and received, and to report the end of the frying time of the fried food 19 in the fryer 14 to the display 25. Furthermore, when a degree of deterioration De of the frying oil 17 in the oil tank 15 is measured based on acid value, viscosity, etc., and the degree of deterioration De reaches a first threshold value, the display 25 may read, for example, “Replace frying oil.”

Furthermore, when the degree of deterioration De of the frying oil 17 reaches a second threshold value (that is greater than the first threshold value), the information processing device 27 may, from that point onward, continuously display on the display 25 that the degree of deterioration De of the frying oil 17 has reached the second threshold value.

Furthermore, the operation of the button switch 23 of the fryer 14 may be disabled so as to forcibly prohibit the use of the fryer 14. The display on the display 25 is fixed in a position that can be visually confirmed by a shopworker other than a person assigned to cooking; e.g., a supervisor.

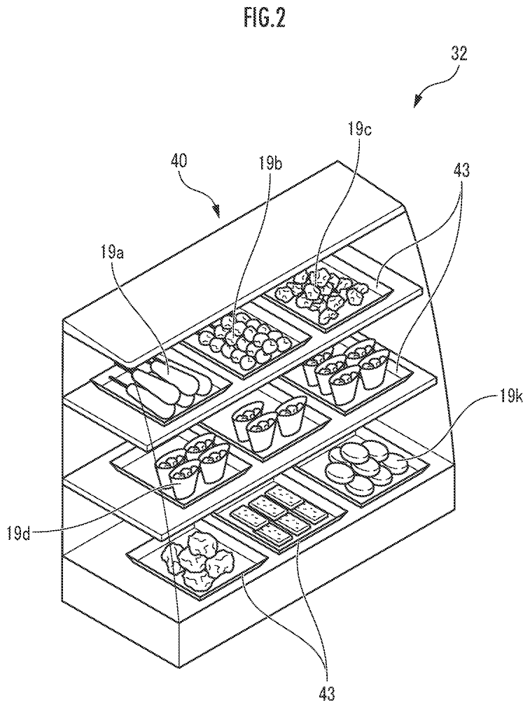

(Display Section) FIG. 2 shows a display case 40 in the facility 32. In the display case 40 serving as a display section, a plurality of fried foods 19a, 19b, . . . , 19k are displayed vertically and horizontally. The fried foods 19 are placed on the same tray 43 for each type and are displayed in the display case 40. If the fried foods 19 in the display case 40 are moved to another location together with the tray 43, the state in which the fried foods 19 are displayed in the display case 40, specific to type, will be changed.

Although not shown in FIG. 2, a camera that recognizes the display state of the display case 40 is installed. The camera is mounted on the ceiling or wall 26, as is the camera 29 in FIG. 1. However, the fried foods 19 displayed in the display case 40 must be arranged in positions where the display state can be visually recognized.

In order to recognize the display state of the display case 40, it is possible, inter alia, for one small camera to be mounted on the lower surface of each shelf of the display case 40, or, in some cases for one to be installed directly above each tray 43. Images captured by the small cameras are sent to the information processing device 27, and are synthesized, analyses, or otherwise processed by the shop business software 28.

As a recognition method other than utilizing cameras, it is also possible for an assigned shopworker managing the display case 40 to recognize the display state based on data inputted manually to an input/output interface provided in the display case 40 or to a portable tablet. Furthermore, it is also possible to detect the number of fried foods 19 contained in each tray 43 from the weight of each tray 43 using a pressure sensor, a weight sensor, etc.

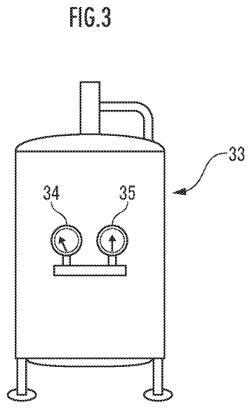

(Storage Tank) FIG. 3 is a front view of a storage tank 33 in which frying oil 17 is stored. The storage tank 33 is installed inside the facility 32 in a location that is easy to get in and out of, or outside the facility 32 in a location shielded from wind and rain and close to the kitchen in the facility 32.

The storage tank 33 is equipped with a remaining amount gauge 34 and a thermometer 35. The remaining amount gauge 34 detects a remaining amount Or of the frying oil 17 in the storage tank 33. The thermometer 35 detects the temperature of the frying oil 17 in the storage tank 33. Detection signals from the remaining amount gauge 34 and the thermometer 35 are transmitted to the information processing device 27.

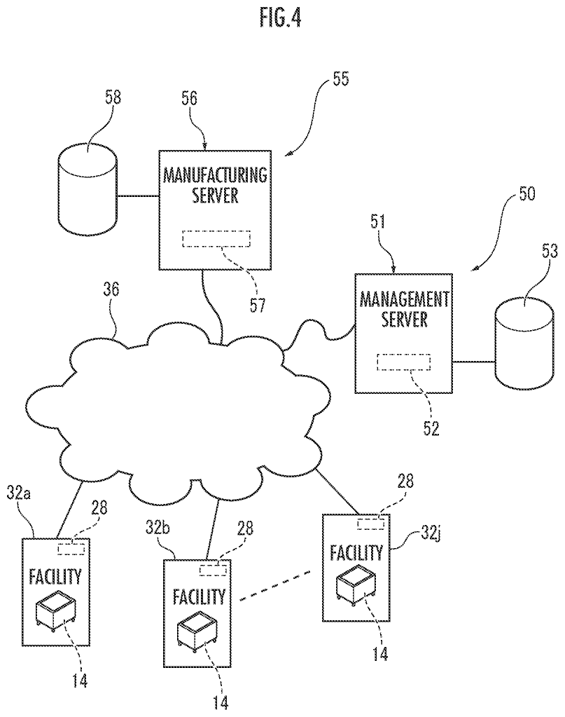

(Network) FIG. 4 is a is a schematic drawing of a network system over which data and information are sent and received via the internet 36. A plurality of facilities 32a, 32b, . . . , 32j, headquarters 50, and a frying oil manufacturer 55 send and receive data and information via the internet 36.

The facilities 32 make up, for example, a convenience store chain or a supermarket chain, and oversight of the shops is given to headquarters 50 serving as an oversight department. The frying oil manufacturer 55 manufactures the frying oil 17 used in the facilities 32. In this example, the frying oil manufacturer 55 also takes on the business of supplying and delivering frying oil to the facilities 32.

Each facility 32 is equipped with a fryer 14 and an information processing device 27 (FIG. 2). The shop business software 28 is installed in the information processing device 27.

A management server 51 is set up in the headquarters 50. A database 53 is connected to the management server 51. The database 53 also serves as a storage device for the management server 51, and information other than that in the database can also be stored as appropriate.

Headquarters business software 52 is installed on the management server 51, and this software executes sales management (e.g., POS systems), etc. The management server 51 has a well-known structure that includes all basic hardware (e.g., CPU, ROM, RAM, interface, etc.) as resources utilized by a variety of computer software.

Oversight of a manufacturing server 56 is given to the frying oil manufacturer 55. The manufacturing server 56 has the same hardware structure as the management server 51 for a basic hardware structure. Business software 57 is installed on the manufacturing server 56. A database 58 is connected to the manufacturing server 56.

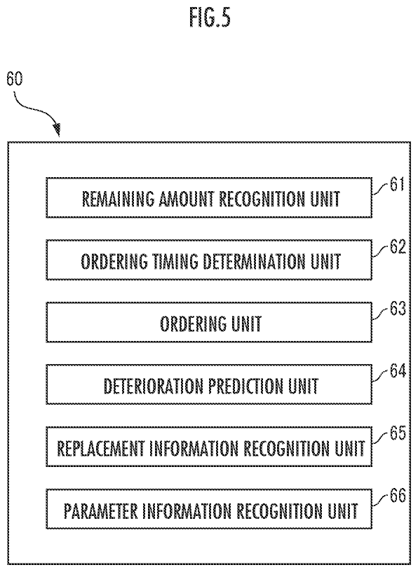

FIG. 5 is a function block diagram of a frying oil ordering device 60. The frying oil ordering device 60 is provided with a remaining amount recognition unit 61, an ordering timing determination unit 62, an ordering unit 63, a deterioration prediction unit 64, a replacement information recognition unit 65, and a parameter information recognition unit 66.

The frying oil ordering device 60 is installed as computer software in the shop business software 28. The remaining amount recognition unit 61, the ordering timing determination unit 62, the ordering unit 63, the deterioration prediction unit 64, the replacement information recognition unit 65, and the parameter information recognition unit 66 shall be described in detail hereinafter.

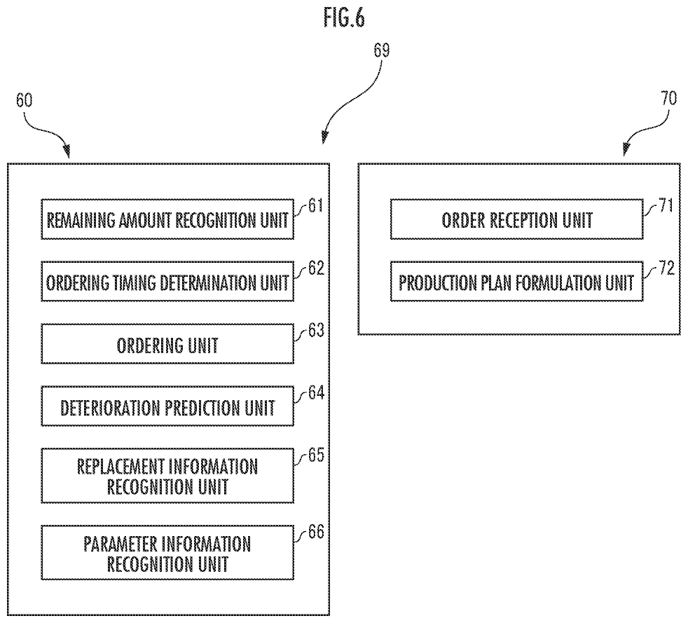

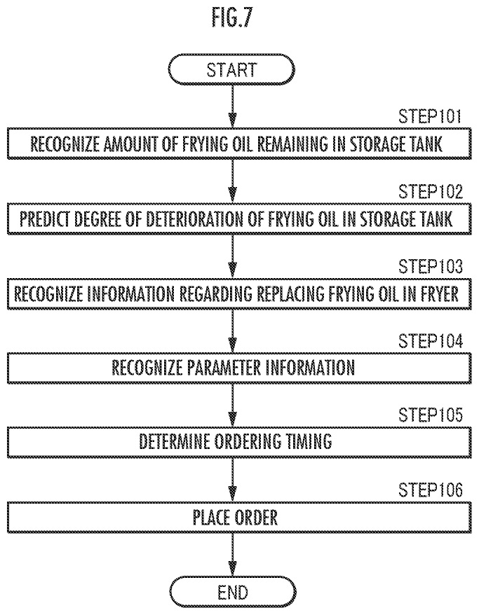

The frying oil ordering device 60 can operate independently of a production planning device 70 of FIG. 6 and can execute a predetermined process. A frying oil ordering method illustrated in FIG. 7 (described hereinafter) is one example of a method comprising only a process that the frying oil ordering device 60 alone executes independently of the production planning device 70 of FIG. 6.

FIG. 6 is a function block diagram of a storage tank management system 69. The storage tank management system 69 is provided with the frying oil ordering device 60 and the production planning device 70. The frying oil ordering device 60 and the production planning device 70 cooperate with each other by sending and receiving data via the internet 36 to carry out the functions of the storage tank management system 69.

The production planning device 70 is included in the business software 57. The production planning device 70 is provided with an order reception unit 71 and a production plan formulation unit 72. The order reception unit 71 and the production plan formulation unit 72 shall be described in detail hereinafter.

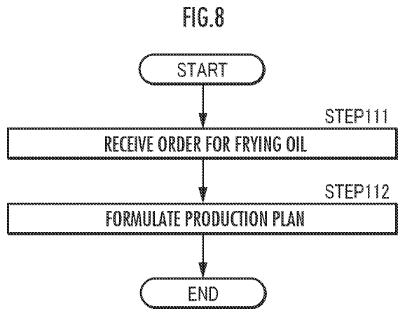

FIGS. 7 and 8 are flowcharts of the frying oil ordering method and the production planning method, respectively, in the storage tank management method. The storage tank management method of the present invention may be constituted of a frying oil ordering method alone, or may be constituted of both a frying oil ordering method and a production planning method. The frying oil ordering method shall be described first.

In STEP 101, the remaining amount recognition unit 61 recognizes the remaining amount Or of the frying oil 17 in the storage tank 33. The remaining amount Or is recognized based on, for example, a detection signal received by the information processing device 27 from the remaining amount gauge 34.

The following is an example of how the ordering timing determination unit 62 assesses the necessity of the facility 32 to replenish the frying oil 17 in relation to the remaining amount Or recognized by the remaining amount recognition unit 61. The ordering timing of each facility 32 is determined in accordance with the assessed necessity.

The ordering timing determination unit 62 assesses that delivery of the frying oil 17 (replenishing the storage tank 33 with the frying oil 17) is not necessary at all at the given point in time when the remaining amount Or is equal to or greater than 80%.

The ordering timing determination unit 62 assesses that the remaining amount Or in the storage tank 33 is an appropriate amount at the given point in time when the remaining amount Or is equal to or greater than 50% and less than 80%. However, replenishing is assessed to be necessary when there is a special circumstance in the facility 32, e.g., an event is scheduled to be held in the near future.

The ordering timing determination unit 62 assesses that replenishment preparations are necessary when the remaining amount Or is equal to or greater than 30% and less than 50%.

The ordering timing determination unit 62 assesses that the frying oil must be replenished promptly when the remaining amount Or is less than 30%.

In STEP 102, the deterioration prediction unit 64 predicts the degree of deterioration De of the frying oil 17 in the storage tank 33. The following methods (a1)-(a3) are given as examples of specific methods whereby the deterioration prediction unit 64 predicts the degree of deterioration De of the frying oil 17 in the storage tank 33.

(a1) It is possible to predict the degree of deterioration De based on an amount of head space Hs in the storage tank 33 because the frying oil 17 deteriorates due to contact with air, or specifically with the oxygen in the air.

FIG. 9 is a graph schematically depicting the relationship between the amount of head space Hs in the storage tank 33 and the deterioration rate Ds of the frying oil 17 in the storage tank 33. The amount of head space Hs on the horizontal axis is indicated by porosity. The porosity is defined by (volume of headspace amount Hs/volume of storage tank 33). A porosity of 100% means that there is no frying oil 17 in the storage tank 33.

There is a distinction between the volume of the storage tank 33 and the maximum storage capacity of the storage tank 33. The term “maximum storage capacity of the storage tank 33” means the maximum amount of frying oil 17 that can be stored in the storage tank 33. The term “volume” of the storage tank 33 means the total of the remaining amount Or of the frying oil 17 in the storage tank 33 and the amount of head space Hs.

The porosity when the frying oil 17 is filled in the storage tank 33 at the maximum storage capacity of the storage tank 33 is Hmin, which is not 0%, but which is slightly greater than 0%. Specifically, even if the remaining amount Or is 100%, head space remains in the upper part inside the storage tank 33 and the frying oil 17 deteriorates due to the air in this head space.

As the amount of head space Hs increases, the amount of the frying oil 17 remaining in the storage tank 33 becomes progressively smaller. Hmin indicates the amount of head space Hs when the maximum amount of the frying oil 17 is stored in the storage tank 33. Head space remains in the upper part inside the storage tank 33 even when the amount of head space Hs is Hmin.

The head space in the storage tank 33 is occupied by air. As the amount of head space Hs in the storage tank 33 increases, the amount of air in the storage tank 33 progressively increases, and a reaction between the frying oil 17 and the air is therefore promoted.

As a result, as the amount of head space Hs increases, the reaction between the frying oil 17 in the storage tank 33 and the air in the headspace accelerates, and the deterioration rate Ds increases, as shown in FIG. 9. Therefore, as the amount of head space Hs increases, the deterioration of the frying oil 17 in the storage tank 33 progresses further.

(a2) The deterioration prediction unit 64 predicts the degree of deterioration De using, as one assessment factor, the elapsed time from when the storage tank 33 was replenished with the frying oil 17 in the storage tank 33.

Due to the replenishing of the frying oil 17 in the storage tank 33, the old frying oil 17 before replenishment and the new frying oil 17 added by the replenishment are mixed in the storage tank 33, and the degree of deterioration De of the frying oil 17 in the storage tank 33 therefore changes discontinuously before and after replenishment. In addition, as described in (a1), the frying oil 17 in the storage tank 33 deteriorates due to contact with air in the head space after replenishment.

Therefore, prediction accuracy can be increased when the degree of deterioration De of the frying oil 17 in the storage tank 33 is predicted based on the elapsed time starting from the time of replenishment.

(a3) The deterioration prediction unit 64 predicts the degree of deterioration De at the time of replenishment as a replenishment-time degree of deterioration Des based on a ratio Rn (=Sp/Or) of a replenishment amount Sp at the time the storage tank 33 was replenished with the frying oil 17 in the storage tank 33 to the remaining amount Or of the frying oil 17 immediately before the replenishment, and predicts the degree of deterioration De of the frying oil 17 in the storage tank 33 after an elapsed time Te from the time of replenishment based on the replenishment-time degree of deterioration Des and the elapsed time Te from the time of replenishment.

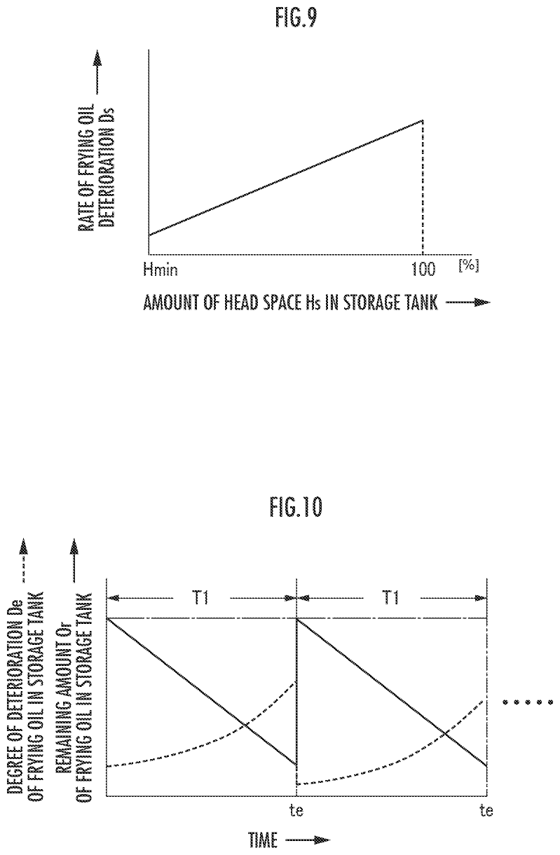

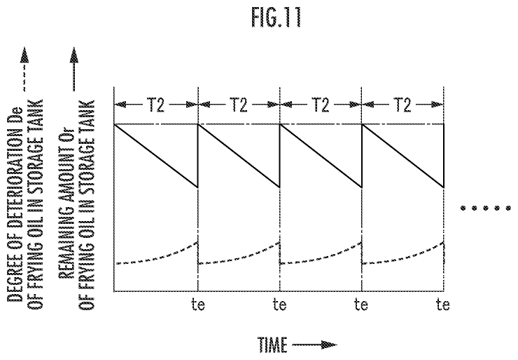

As the ratio Rn increases, i.e., as the remaining amount Or decreases and the replenishment amount Sp increases, the replenishment-time degree of deterioration Des decreases to a progressively greater extent with respect to the degree of deterioration De before replenishment. As the elapsed time Te from the time of replenishment increases, the degree of deterioration De gradually increases. This feature is schematically described with reference to FIGS. 10 and 11.

FIGS. 10 and 11 are graphs schematically depicting the change over time in the remaining amount Or (solid lines) and the degree of deterioration De (dashed lines) of the frying oil 17 in the storage tank 33.

In order to simplify the explanation, in FIGS. 10 and 11, it is assumed that the storage tank 33 is replenished with the frying oil 17 every replenishment cycle T1 and T2. It is then assumed that the rate of decrease in the remaining amount Or of the storage tank 33 is the same in both FIGS. 10 and 11. The letters to indicate the replenishment time. The alternate long and short dash line extending parallel to the horizontal axis indicates the level where the remaining amount Or in the storage tank 33 is 100%, i.e., the maximum storage amount of the frying oil 17.

Because T1 is greater than T2, the fluctuation width of the degree of deterioration De is greater in FIG. 10 than in FIG. 11. The maximum value of the degree of deterioration De is maintained lower in FIG. 11.

In STEP 103, the replacement information recognition unit 65 recognizes information regarding replacing the frying oil 17 in the oil tank 15 of the fryer 14. Because the volume of the oil tank 15 is fixed, the amount of the frying oil 17 consumed per replacement of the frying oil 17 in the oil tank 15 is fixed.

The replacement information is, for example, information on the date and time at which the frying oil 17 in the fryer 14 is replaced. The date and time may be manually inputted to a tablet by a shopworker, or can be automatically detected from an image captured by the camera 29. The replacement information is written into a storage device (not shown) of the shop business software 28.

A shopworker assigned to the facility 32 fries the fried foods 19 using the frying oil 17 in the oil tank 15 of the fryer 14. The degree of deterioration De of the frying oil 17 in the oil tank 15 increases as the quantity of fried foods 19 fried in the same frying oil 17 increases after the frying oil 17 in the oil tank 15 has been replaced with new frying oil 17. In order to guarantee the quality of the fried foods 19 sold in the facility 32, the frying oil 17 in the oil tank 15 is replaced before the degree of deterioration De of the frying oil 17 in the oil tank 15 reaches a threshold value.

In STEP 104, the parameter information recognition unit 66 recognizes parameter information. The parameter information includes at least one of the following: the storage capacity of the storage tank 33, the period of preserving the frying oil 17 in the storage tank 33 up to the present time, the consumption rate of the frying oil 17 in the facility 32, the attributes of the facility 32, information relating to events that affect sales of the fried foods 19 in the facility 32, information on future predicted sales predicted based on past sales performance of the fried foods 19 by type, the present date and time, and weather information.

The attributes of the facility 32 include the environment where the facility 32 is located and the scale of the facility 32 (e.g., the number of shopworkers and the shop area). Furthermore, as a supplement, the environment where the facility 32 is located can be divided into, for example, an office district, a student district, a resort area, the area in front of a transport station (where customers come to the shop on foot), and a suburb (where customers come to the shop by car).

Events include, for example, road construction, construction work, athletic meets (e.g., school athletic meets and sports days such as baseball and soccer), fireworks festivals, entrance ceremonies, coming-of-age ceremonies, etc. At fireworks festivals, the take-out of the deep-fried and potato varieties of fried foods 19 tends to increase after the evening.

Past sales performance includes, for example, sales performance for the last week, the same day of the week last week, the same month last year, and the previous event day. The predicted sales volume in the future can be calculated by using, inter alia, the remaining time from the current date and time to the closing time of the given day, the weather forecast, and the current ambient temperature as prediction parameters. For example, on a rainy day with an ambient temperature of 18° C. or less, sales of the cream croquette variety of fried food 19 will increase. Therefore, on such a day, it is preferable to increase the number of cream croquette fried foods 19 cooked. The current date and time also includes information about the day of the week on the given day and whether the given day is a school or company summer vacation or a holiday.

Regarding the period of preserving the frying oil 17 in the storage tank 33 up to the given point in time, a preservation period start time is set to, for example, the most recent time te of replenishing the frying oil 17 in the storage tank 33. In general, the replenishment of the frying oil 17 in the storage tank 33 would not be the replenishment of the frying oil 17 in an empty storage tank 33, but would be the replenishment of new frying oil 17 in a storage tank 33 in which some amount of old frying oil 17 remains.

Therefore, the start time of the period for preserving old frying oil 17 occurs before the most recent time te of replenishing the frying oil 17 in the storage tank 33, but because there is normally less old frying oil 17 than new frying oil 17, the preservation period of old frying oil 17 is ignored and the most recent replenishment time te is used as the starting point of the preservation period of frying oil 17 in the storage tank 33.

To supplement the preservation period, if there is a small amount of frying oil 17 in the storage tank 33, the amount of oxygen in the space (head space) in the storage tank 33 increases; therefore, the deterioration rate of the frying oil 17 increases and the flavor of the fried food deteriorates sooner.

An appropriate countermeasure would involve, for example, preventing the remaining amount Or from falling to 40% or less. For example, when the remaining amount Or falls below 50%, frying oil 17 is automatically ordered, and the remaining amount Or of the frying oil 17 in the storage tank 33 is prevented from falling to 40% or less so that the flavor of the fried food does not decrease during the preservation period.

The future remaining amount Or in the storage tank 33 is predicted from the relationship between the storage capacity of the storage tank 33 and the consumption rate of the frying oil 17. It is predicted that the remaining amount Or will reach 50% in the remaining X days. The frying oil manufacturer 55 can infer that it is necessary to be notified of this prediction by the facility 32, or to make a prediction based on data received from the facility 32 and prepare a delivery scheme within X days.

The ambient temperature also causes fluctuation in the degree of deterioration De of the frying oil 17 in the storage tank 33. When the ambient temperature is high, the frying oil 17 in the storage tank 33 deteriorates to a greater extent than when the ambient temperature is low. Therefore, in order to maintain the flavor of the frying oil 17, it is preferable to adjust the porosity of the storage tank 33 in accordance with the ambient temperature. For example, when the ambient temperature is low at less than 25° C., the porosity is kept at 50% or less, and when the ambient temperature is high at 25° C. or higher, the porosity is kept at 40% or less, which is less than that at low temperature, to minimize deterioration.

In STEP 105, the ordering timing determination unit 62 determines an ordering timing Ct.

Specific examples (b1) and (b2) in which the ordering timing determination unit 62 determines the ordering timing Ct shall be described.

(b1) The ordering timing determination unit 62 determines the ordering timing Ct such that the degree of deterioration De predicted by the deterioration prediction unit 64 can be maintained within an allowable range.

The allowable range of the degree of deterioration De of the frying oil 17 in the storage tank 33 is a range at which the quality (flavor) of the fried foods 19 can be guaranteed when the fried foods 19 are cooked in the fryer 14. Therefore, a threshold value of the degree of deterioration De for guaranteeing quality is set, and this threshold value is a threshold value of the allowable range.

(b2) The ordering timing determination unit 62 determines the ordering timing Ct such that the amount of head space Hs does not exceed a predetermined value in order to maintain the degree of deterioration De in the allowable range.

The air in the head space in the storage tank 33 causes deterioration of the frying oil 17. In addition, as the amount of head space Hs increases, the deterioration rate Ds of the frying oil 17 in the storage tank 33 progressively increases.

The amount of head space Hs does not reach 0 even if the frying oil 17 completely fills the storage tank 33, and the degree of deterioration De therefore progresses even if the frying oil 17 in the storage tank 33 is not consumed at all while the storage capacity is maintained. However, with a smaller amount of head space Hs, the deterioration rate Ds is commensurately lower. In addition, there is a certain time lag Tl from the time the order is placed until the frying oil 17 reaches the storage tank 33.

Therefore, using the replenishment-time degree of deterioration Des of the frying oil 17 in the storage tank 33 at a predetermined point in time (usually the replenishment time) as a starting point, the ordering timing determination unit 62 can calculate the deterioration rate Ds at intervals of a certain time A from this starting point by time integration of the deterioration rate Ds corresponding to the amount of head space Hs at each point in time. Thus, the point in time when the calculated degree of deterioration De reaches the threshold value is designated as the ordering timing Ct.

(b3) The ordering timing determination unit 62 determines the ordering timing Ct such that the elapsed time Te from the time of replenishment, when the storage tank 33 is replenished with the frying oil 17 in the storage tank 33, is maintained within a time needed to maintain the degree of deterioration De in the allowable range.

In STEP 106, the ordering unit 63 places an order with the supplier of the frying oil 17 based on the ordering timing Ct determined by the ordering timing determination unit 62. Typically, the ordering unit 63 places an order when the current time becomes the ordering timing Ct determined by the ordering timing determination unit 62.

In FIG. 8, in STEP 111, the order reception unit 71 receives the order for frying oil 17 from the ordering unit 63.

In STEP 112, the production plan formulation unit 72 formulates a plan for producing the frying oil 17 based on the order received by the order reception unit 71.

### Effects of Embodiment

According to the storage tank management system 69, the ordering timing Ct for the frying oil 17 is determined by considering at least one of the following, in addition to the remaining amount Or of the frying oil 17 in the storage tank 33: the degree of deterioration De of the frying oil 17 in the storage tank 33, the information regarding replacing the frying oil 17 in the fryer in the facility 32, and the parameter information on parameters that affect future sales of the fried foods 19 in the facility 32.

Specifically, the ordering timing Ct for the frying oil 17 is determined by considering factors important for determining the ordering timing Ct for the frying oil 17, such as the degree of deterioration De and the shop status. As a consequence, the remaining amount Or of the frying oil 17 in the storage tank 33 can be properly managed, and the storage tank 33, which does not hinder the cooking of the fried foods 19 in the facility 32, can be properly managed.

The frying oil 17 in the storage tank 33 undergoes deterioration with the passage of time due to, inter alia, contact with air in the storage tank 33. Because the frying oil 17 that has undergone such deterioration has already deteriorated even after replacement, the frying oil 17 affects characteristics of the fried food 19 such as taste and color, and will need to be replaced again in a short period of time.

Therefore, according to the storage tank management system 69, the degree of deterioration De of the frying oil 17 in the storage tank 33 is predicted, and the ordering timing Ct is determined such that the degree of deterioration De can be maintained within the allowable range. The degree of deterioration De of the frying oil 17 deteriorating in the storage tank 33 can thereby be maintained within the allowable range. As a result, suitable taste, color, and other characteristics can be maintained in the cooked food cooked with the replaced frying oil 17.

The frying oil 17 in the storage tank 33 deteriorates due to contact with the air in the head space. The amount of air in the storage tank 33 is commensurately greater with a greater amount of head space Hs; therefore, the deterioration rate of the frying oil 17 in the storage tank 33 becomes faster and the fried foods lose flavor sooner.

To counter this problem, in the storage tank management system 69, the ordering timing Ct is determined so as not to exceed the amount of head space Hs needed to maintain the degree of deterioration within the allowable range. It is thereby possible to manage the frying oil 17 in the storage tank 33 so as not to cause the fried foods cooked in the frying oil 17 in the storage tank 33 to lose flavor.

In the storage tank management system 69, by determining the ordering timing Ct so as not to exceed the amount of head space Hs needed to maintain the degree of deterioration De within the allowable range, it is possible to absorb any error in the ordering timing Ct and to maintain the degree of deterioration De of the frying oil 17 in the storage tank 33 within the allowable range.

The frying oil 17 in the storage tank 33 deteriorates as the frying oil 17 continues to be in contact with the air in the head space. According to the storage tank management system 69, it is possible to increase the accuracy of determining the ordering timing Ct for maintaining the degree of deterioration De within the allowable range, by having the determination of the ordering timing Ct involve the time elapsed from the time of replenishment when the storage tank 33 was replenished with the frying oil 17 in the storage tank 33.

When the storage tank 33 is replenished with frying oil 17, the old frying oil 17 before the replenishment and the replenished new frying oil 17 mix together. Therefore, the degree of deterioration De of the frying oil 17 in the storage tank 33 immediately after the replenishment is related to a ratio of the remaining amount Or of the frying oil 17 immediately before the replenishment to the replenishment amount of the frying oil 17. Furthermore, the frying oil 17 in the storage tank 33 deteriorates with the passage of time after the replenishment.

Therefore, according to the storage tank management system 69, by predicting the degree of deterioration De of the frying oil 17 in the storage tank 33 after an elapsed time from the time of replenishment based on the replenishment-time degree of deterioration and the elapsed time from the time of replenishment, it is possible to properly predict the degree of deterioration De of the frying oil 17 after replenishment.

Because the frying oil 17 in the storage tank 33 is used to cook fried foods 19 in the fryer of the facility 32, the future remaining amount Or of the frying oil 17 in the storage tank 33 is affected by the frequency with which the frying oil 17 in the fryer is replaced.

In view of this, according to the storage tank management system 69, because the ordering timing Ct is determined by considering information regarding replacing the frying oil 17 in the fryer, it is possible to determine an ordering timing Ct coordinated with the consumption of frying oil 17 in the fryer.

Because the frying oil 17 in the storage tank 33 is consumed in accordance with the sales of the fried foods 19 in the facility 32, the future remaining amount Or of the frying oil 17 in the storage tank 33 is affected by the parameter information, which is related to the sales of the fried foods 19 in the facility 32.

According to the storage tank management system 69, because the ordering timing Ct is determined by considering parameter information, it is possible to determine an ordering timing Ct coordinated with the future sales of the fried foods 19 in the facility 32.

According to the storage tank management system 69, the manufacturing server 56 formulates a plan for producing the frying oil 17 based on the order for the frying oil 17 from the facility 32, and the manufacturer can thereby produce the frying oil 17 to meet demand for the frying oil 17 in the facility 32.

(Supplemental Descriptions and Modifications)

The manufacturing server 56 of the embodiments constitutes an order recipient server of the present invention. A server managed or overseen by a manufacturer is not provided by way of limitation on the order recipient server of the present invention. This is because if the manufacturer is a subcontractor that manufactures the frying oil 17 according to a production plan established by a parent company, the manufacturing server 56 may be managed or overseen by the parent company.

The storage tank management system of the present invention can include both the frying oil ordering device 60 and the production planning device 70, as does the storage tank management system 69 of FIG. 6. However, the storage tank management system of the present invention may be configured solely from the storage tank management system 69 of FIG. 5 without being equipped with the production planning device 70.

In the embodiments of FIGS. 5 and 6, the ordering unit 63 is included in the frying oil ordering device 60 installed as computer software in the information processing device 27 provided to the facility 32. However, although the ordering timing determination unit 62 is left in the information processing device 27, the ordering unit 63 may be transferred to the headquarters business software 52 of the management server 51 of the headquarters 50.

In such instances, the ordering unit 63 of the headquarters 50 would receive ordering timings Ct from a plurality of facilities 32, perform a process such as collecting ordering timings Ct that have the same date, and then transmit an order integrating the orders from the plurality of facilities 32 to the production planning device 70 of the frying oil manufacturer 55.

In the embodiments, an electric fryer 14 is used as the fryer. The fryer of the present invention is a cooking container in which fried foods are fried in frying oil; therefore, any heat source may be used and the fryer may be a gas or electromagnetic fryer, pan, or the like.

In the embodiments, the deterioration prediction unit 64 predicts the current or future degree of deterioration De of the frying oil 17 in the storage tank 33. In addition, the ordering timing determination unit 62 determines the ordering timing Ct based on a variety of inputs and information. It is also possible to use artificial intelligence (AI), etc., in the prediction performed by the deterioration prediction unit 64 and in the determination of the ordering timing Ct performed by the ordering timing determination unit 62.

### Key to Symbols

14 Fryer
15 Oil tank
17 Frying oil
19 Fried food
27 Information processing device
32 Facility
33 Storage tank
34 Remaining amount gauge
51 Management server
55 Frying oil manufacturer
56 Manufacturing server (order recipient server)
60 Frying oil ordering device
61 Remaining amount recognition unit
62 Ordering timing determination unit
63 Ordering unit
64 Deterioration prediction unit
65 Replacement information recognition unit
66 Parameter information recognition unit
69 Storage tank management system
70 Production planning device
71 Order reception unit
72 Production plan drafting unit

1. A system for managing a storage tank which is installed as incidental equipment in a facility where fried foods to be sold are cooked, and in which frying oil used for the fried foods is stored, the system comprising a processor and a memory having program code stored therein for execution by the processor,
wherein the processor executes the computer program code to:
recognize an amount of frying oil remaining in the storage tank; and
determine an ordering timing for the storage tank to be replenished with the frying oil based on the recognized amount and at least one of a degree of deterioration of the frying oil in the storage tank, information regarding replacing the frying oil in a fryer in the facility, and parameter information relating to parameters that affect future sales of the fried foods.

2. The storage tank management system according to claim 1, wherein the processor executes the computer program code to: further,
place an order with an order recipient for the frying oil based on the determined ordering timing.

3. The storage tank management system according to claim 1, wherein the processor executes the computer program code to:
predict the degree of deterioration of the frying oil in the storage tank, and
determine the ordering timing such that the predicted degree of deterioration can be maintained within an allowable range.

4. The storage tank management system according to claim 3, wherein the processor executes the computer program code to:
predict the predicted degree of deterioration using an amount of head space in the storage tank as an assessment factor; and
determine the determined ordering timing so as not to exceed the amount of head space needed in order to maintain the predicted degree of deterioration within the allowable range.

5. The storage tank management system according to claim 3, wherein the processor executes the computer program code to: further,
predict the predicted degree of deterioration using an elapsed time from a time of replenishment when the storage tank is replenished with the frying oil in the storage tank as one assessment factor; and
determine the determined ordering timing such that the elapsed time from the time of replenishment when the storage tank is replenished with the frying oil in the storage tank is maintained within the time needed to maintain the degree of deterioration within the allowable range.

6. The storage tank management system according to claim 3, wherein the processor executes the computer program code to: further,
predict the predicted degree of deterioration at the time of replenishment as a replenishment-time degree of deterioration based on a ratio of a replenishment amount at the time the storage tank was replenished with the frying oil in the storage tank to the amount of the frying oil remaining immediately before the replenishment; and
predict the degree of deterioration of the frying oil in the storage tank after an elapsed time from the time of replenishment based on the replenishment-time degree of deterioration and the elapsed time from the time of replenishment.

7. The storage tank management system according to claim 1, wherein the processor executes the computer program code to: further, recognize the information regarding replacing the frying oil in the fryer in the facility; and
determine the determined ordering timing by considering the recognized information regarding replacing the frying oil in the fryer in the facility.

8. The storage tank management system according to claim 1, wherein the processor executes the computer program code to: further, recognize as parameter information at least one parameter among attributes of a shop serving as the facility, information relating to events that affect sales of the fried foods in the shop, future predicted sales predicted based on past sales performance of the fried foods by type, time to cook the fried foods by type, the present date and time, the degree of deterioration of the frying oil, and weather information; and
determine the determined ordering timing by considering the recognized parameter information.

9. The storage tank management system according to claim 1,
wherein the processor executes the computer program code to further,
place an order with an order recipient for the frying oil based on the determined ordering timing, and
wherein the system further comprises an order recipient server that is managed by a frying oil manufacturer serving as the order recipient for the frying oil, the server comprising a processor and a memory having program code stored therein for execution by the processor of the server that executes the computer program code of the server to:
receive the placed order; and
formulate a plan for producing the frying oil based on the received order.

10. A method for managing a storage tank which is installed as incidental equipment in a facility where fried foods to be sold are cooked, and in which frying oil used for the fried foods is stored, the storage tank management method comprising the steps of:
recognizing an amount of frying oil remaining in the storage tank; and
determining an ordering timing for the storage tank to be replenished with the frying oil based on the remaining amount recognized in the remaining amount recognition step and at least one of a degree of deterioration of the frying oil in the storage tank, information regarding replacing the frying oil in a fryer in the facility, and parameter information relating to parameters that affect future sales of the fried foods.
